(19) United States
(12) Patent Application Publication
(10) Pub. No.: US 2016/0305556 A1
(43) Pub. Date: Oct. 20, 2016

(54) METERING VALVE FOR DIAMOND DRILLING

(71) Applicant: HILTI AKTIENGESELLSCHAFT, Schaan (LI)

(72) Inventors: Christian Sattler, Biessenhofen (LI); Sonya Woerz, Penzing (DE)

(21) Appl. No.: 15/102,679

(22) PCT Filed: Dec. 9, 2014
(86) PCT No.: PCT/EP2014/076995

§ 371 Date: Jun. 8, 2016

(30) Foreign Application Priority Data
Dec. 13, 2013 (EP) 13197047.7

(51) Int. Cl. F16K 5/04; F16K 31/60; F16K 5/12

(52) U.S. Cl. CPC F16K 5/0407; F16K 5/12; F16K 31/602

(57) ABSTRACT

Shut-off device for at least partially blocking a fluid in a fluid line, including a blocking device which has a substantially cylindrical basic body and includes a first end and a second end, wherein the blocking device can be positioned in the fluid line and, by rotation in a direction of rotation (A) about an axis of rotation (R), can be reversibly adjusted from a blocking position, in which no fluid can flow through the blocking device, into a throughflow position, in which fluid can flow through the blocking device. The blocking device includes a first through-opening and a second-through opening, wherein the cross section of the first through-opening is smaller than the cross section of the second through-opening.

The present invention relates to a shutoff device for the at least partial blocking of a fluid in a fluid line. The shutoff device includes a blocking device having an essentially cylindrical base body that has a first end and a second end, the blocking device being positionable in the fluid line and adjustable by rotation in one direction of rotation around an axis of rotation reversibly from a blocking position in which no fluid is able to flow through the blocking device into a flow-through position in which fluid is able to flow through the blocking device.

### BACKGROUND

Work on particularly hard materials, such as for example (core) drilling in rock, always requires a certain amount of coolant to cool the tool and bind the released drilling mud and transport it away. Cooling systems for use on drilling units such as on core drilling units, for example, have long been known. Water is usually used as the coolant.

Cooling systems of this type include essentially a supply of coolant that is normally in the form of a connection to a water line, a device (e.g. a pump) to transport the coolant to the tool and at least one coolant line for the feed of the coolant to the tool. The volume of the supply of coolant, the output of the device for the transport of the coolant and the quantity (volume) of coolant delivered to the tool is a function of, among other things, the material to be processed, the size and output of the machine tool and the desired working speed (advance of the tool in the material). In the determination and setting of these different operating parameters, the metering of the amount of coolant delivered to the tool is always a recurring problem for the user of the cooling system, since the quantity of coolant delivered must be neither too large nor too small. In particular, relatively small quantities of coolant may frequently be only unsatisfactorily delivered to a tool in cooling systems of the prior art. The cause lies primarily in the configuration of the shutoff device, which is usually in the form of a manually actuatable control valve positioned in the coolant line that regulates the quantity or the volume of coolant delivered to the tool. These shutoff devices, which are conventionally in the form of a control valve, do not allow sufficiently precise metering of small quantities of coolant, so that the control valve may either only be completely closed or opened far too wide. As a result, either no coolant at all or too much coolant flows to the tool.

A shutoff device of this type in a fluid line is described, for example, in PCT application WO 2011/091798. WO 2011/091798 describes a drain valve with which the volume of a fluid flowing through the valve may be regulated. The drain valve has a valve housing including an inlet opening and an outlet opening. Respective fluid lines are connected to both the input and to the output openings. In the valve housing is a plate-shaped control element that may be rotated by a manual element in the valve housing to regulate the volume of the fluid flowing through the drain valve. For this purpose, the plate-shaped control element is rotated in front of the input and output opening in such a way that the cross section of the flow-through opening at the input and output opening is reduced in size. As a result of the reduction of the cross section, the quantity of fluid that may pass through the drain valve is reduced.

### SUMMARY OF THE INVENTION

As described above, one disadvantage even with the shutoff valve illustrated in WO 2011/091798 is that it is unable to meter small quantities of coolant with sufficient precision.

It is an object of the present invention to provide an improved shutoff device for the at least partial blocking of a fluid in a fluid line with which precise metering of even small quantities of coolant is possible.

The present invention provides a shutoff device for the at least partial blocking of a fluid in a fluid line, including a blocking device having an essentially cylindrical base body, that has a first end and a second end, the blocking device is positionable in the fluid line and is adjustable by rotation in a direction (A) around an axis of rotation (R) reversibly from a blocking position in which no fluid is able flow through the blocking device into a flow-through position in which fluid is able to flow through the blocking device.

According to the present invention it is provided that the blocking device includes a first flow-through opening and a second flow-through opening, where the cross-section of the first flow-through opening is smaller than the cross-section of the second flow-through opening. As a result of the smaller cross-section of the first flow-through opening, the ability to regulate the flow for smaller quantities of fluid through the blocking device is improved.

To obtain a preferably continuous increase of the quantity of fluid that flows through the blocking device by a corresponding rotation of the blocking device it may be provided according to one advantageous embodiment that the first flow-through opening and the second flow-through opening are connected to each other by a passage opening along the lateral surface of the cylindrical base body.

In one additional advantageous embodiment of the present invention it may be provided that the first flow-through opening has an essentially wedge-shaped cross-section. As a result of the wedge-shaped cross-section of the first flow-through opening, depending on the rotational position of the blocking device in the fluid line, the effective size of the first flow-through opening and thus the quantity of fluid that may flow through the blocking device and to the tool may be adjusted.

In one additional advantageous embodiment of the present invention it may be provided that the wedge-shaped cross-section has at least a first surface with a first surface edge and a second surface edge as well as a second surface with a first surface edge, a second surface edge and a third surface edge, the first surface extending in parallel to the axis of rotation and the second surface extending at an angle to the axis of rotation in such a way that a first end of the second surface edge and a first end of the third surface edge meet essentially at a point at the second end of the cylindrical base body. Consequently, by a corresponding rotation of the blocking device in the fluid line, the effective size of the first flow-through opening and thus the quantity of fluid that may flow through the blocking device and to the tool may be continuously increased or reduced.

According to one further advantageous embodiment of the present invention, it may be provided that on the cylindrical base body of the blocking device, in direction (B), the first flow-through opening may be positioned in front of the second flow-through opening. This arrangement ensures that in the event of a corresponding rotation of the blocking device in the fluid line, fluid first flows through the first flow-through opening and only as the blocking device is rotated further through the second flow-through opening. Consequently, a correspondingly small quantity of fluid first flows through the blocking device to the tool.

In one further advantageous embodiment of the present invention, it may be provided that on the cylindrical base body of the blocking device in direction (B), the first surface of the first flow-through opening is positioned in front of the second surface of the first flow-through opening. This arrangement ensures that the enlargement of the cross-section of the first flow-through opening by a corresponding rotation of the blocking device is always accomplished by an increase with an increasingly smaller portion of the cross-section.

According to one further advantageous embodiment of the present invention, it may be provided that the blocking device may be oriented by rotation in the fluid line in such a way that a flow of fluid through the blocking device is possible only through the first flow- through opening, through the first flow-through opening and the second flow-through opening, or only through the second flow-through opening. This arrangement ensures either a continuous or a sudden increase in the flow volume of fluid through the blocking device.

### BRIEF DESCRIPTION OF THE DRAWINGS

The present invention is explained in greater detail below with reference to advantageous exemplary embodiments illustrated in the accompanying drawings

FIG. 1 shows a perspective view of a shutoff device according to the present invention containing a blocking device with a cylindrical base body;

FIG. 2 shows a top view of the shutoff device in a fluid line;

FIG. 3 shows a side view of the shutoff device including the blocking device having the cylindrical base body;

FIG. 4 shows a sectional view through the shutoff device along line A-A in FIG. 3.

FIG. 5 shows a perspective view of the shutoff device on a cut fluid line;

FIG. 6 shows a perspective view of the underside of the shutoff device on the cut fluid line;

FIG. 7 shows a bottom view of the shutoff device including the first passage opening and the second passage opening on the cut fluid line;

FIG. 8 shows a detail of the underside of the shutoff device shown in FIG. 7 including the first passage opening and the second passage opening on the cut fluid line;

FIG. 9 shows a side view in the flow direction of the shutoff device on the cut fluid line with the blocking device in a 0° position;

FIG. 10 shows a side view opposite the flow direction of the shutoff device on the cut fluid line with the blocking device in a 0° position;

FIG. 11 shows a side view in the flow direction of the shutoff device on the cut fluid line with the blocking device in a 25° position;

FIG. 12 shows a side view opposite the flow direction of the shutoff device on the cut fluid line with the blocking device in a 25° position;

FIG. 13 shows a side view in the flow direction of the shutoff device on the cut fluid line with the blocking device in a 45° position;

FIG. 14 shows a side view opposite the flow direction of the shutoff device on the cut fluid line with the blocking device in a 45° position;

FIG. 15 shows a side view in the flow direction of the shutoff device on the cut fluid line with the blocking device in a 55° position;

FIG. 16 shows a side view opposite the flow direction of the shutoff device on the cut fluid line with the blocking device in a 55° position;

FIG. 17 shows a side view in the flow direction of the shutoff device on the cut fluid line with the blocking device in a 90° position;

FIG. 18 shows a side view opposite the flow direction of the shutoff device on the cut fluid line with the blocking device in a 90° position.

### DETAILED DESCRIPTION

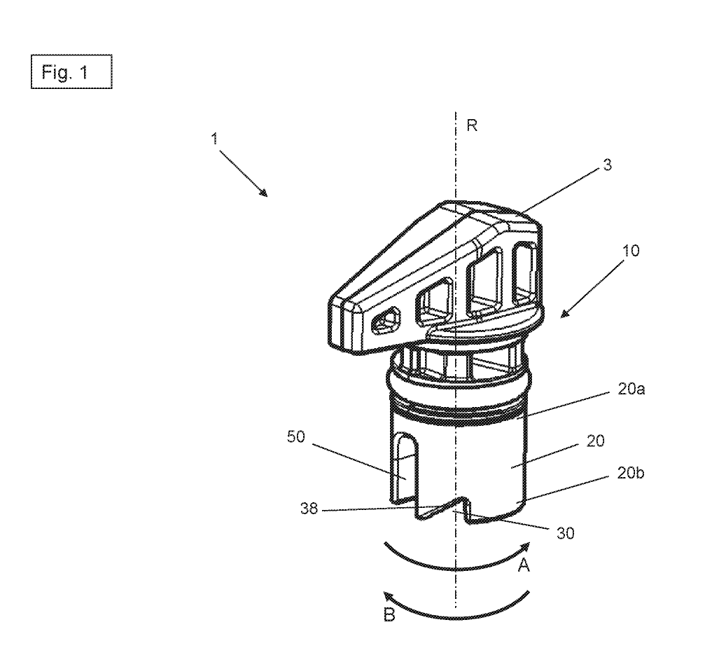

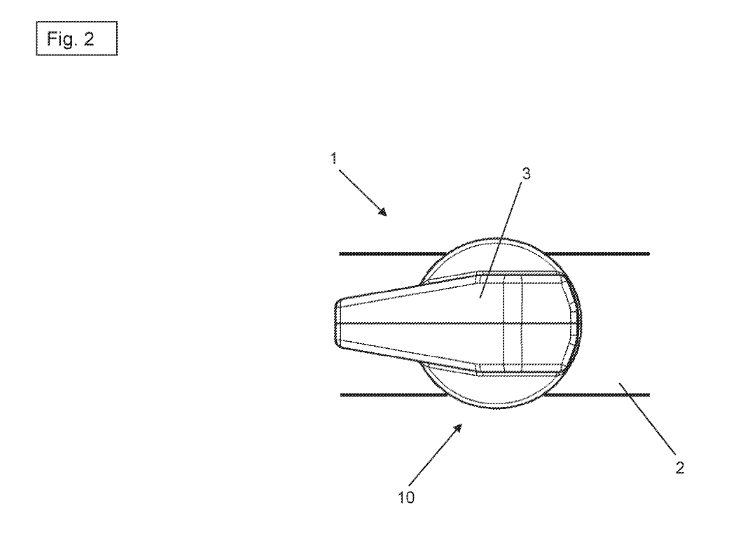

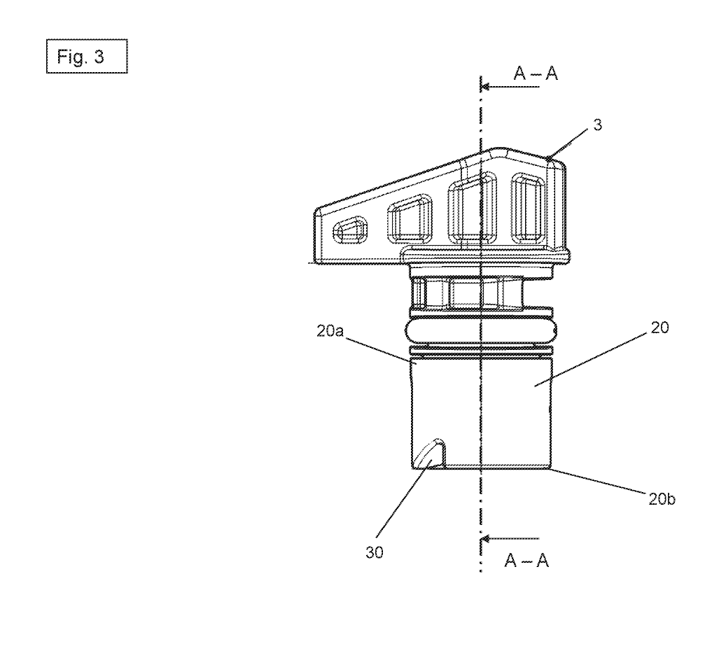

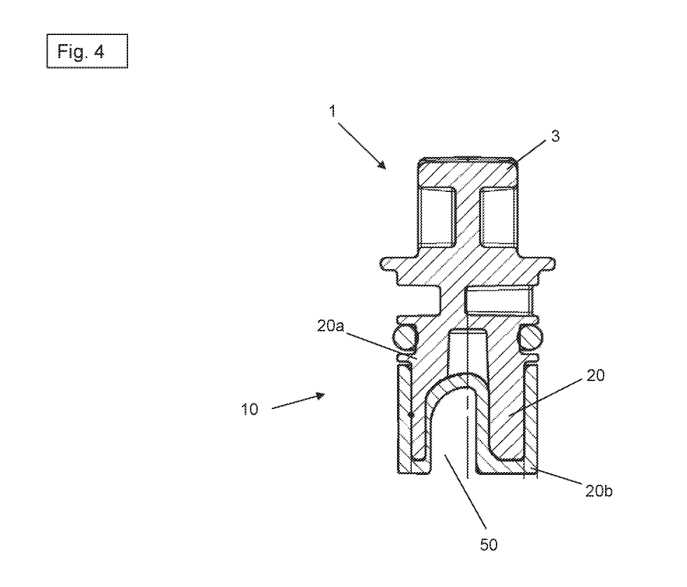

FIGS. 1 through 4 show a shutoff device 1 for the at least partial blocking of a fluid (not shown) in a fluid line 2. The fluid may be water or another fluid. It is also possible to use a gas. The shutoff device 1 may be a part of a cooling or flushing system (not shown), which may be used to cool a machine tool (not shown) with the fluid or to flush the tool of the machine tool (e.g. a core bit) and clean it of drilling mud. The machine tool may be a core drilling machine or a similar machine.

The shutoff device 1 contains a control element 3 and a blocking device 10 with an essentially cylindrical base body 20.

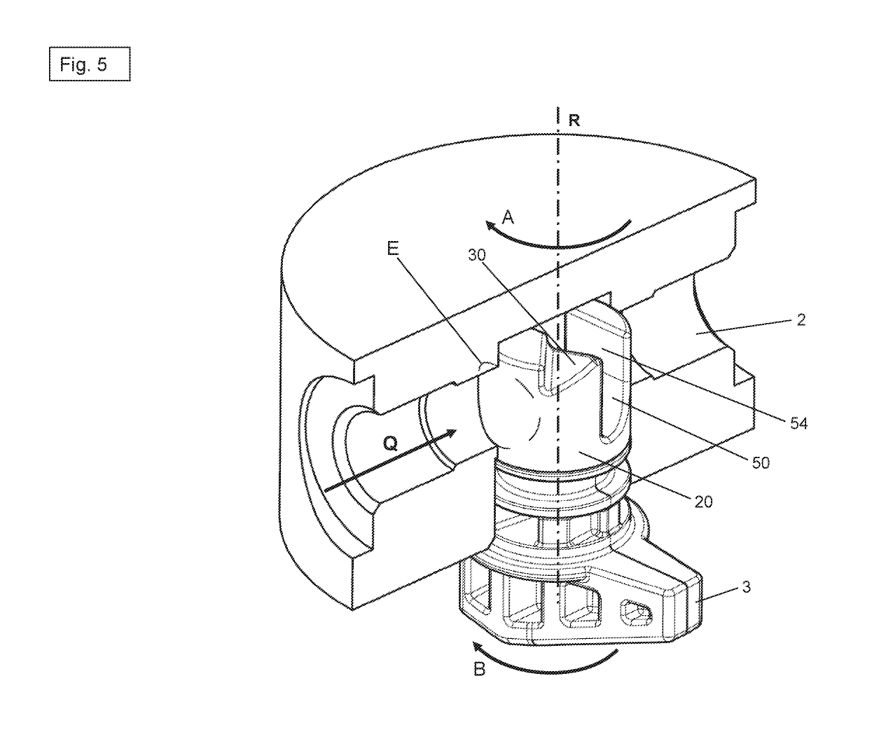

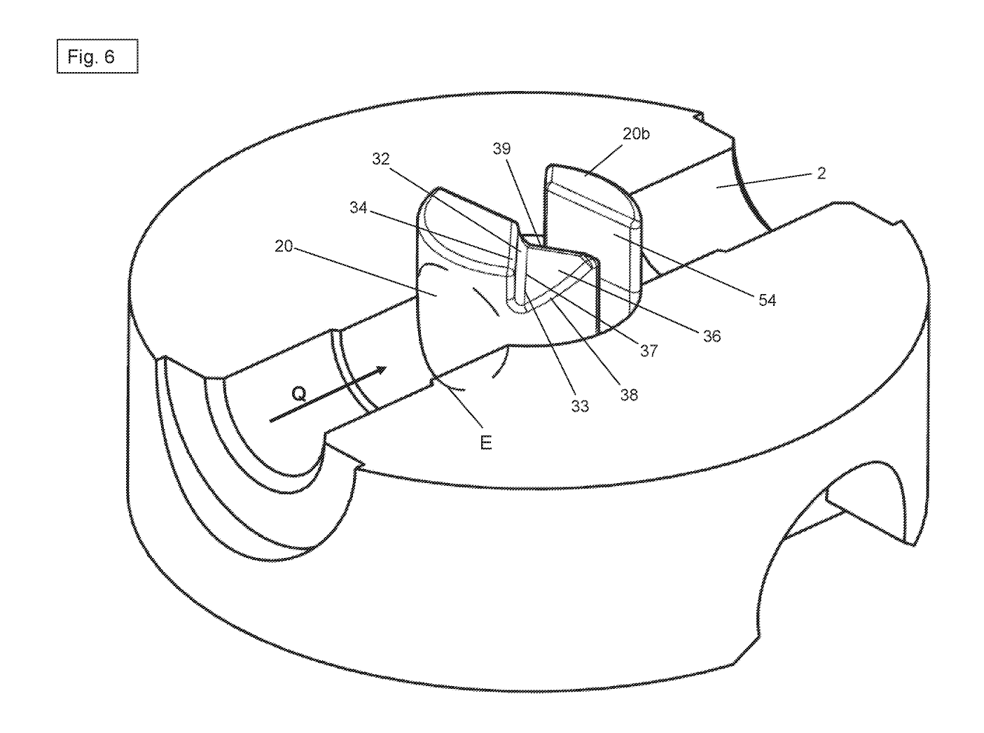

Base body 20 has a first end 20a and a second end 20b. Blocking device 10 is positioned in a fluid line 2 in such a way that first end 20a of base body 20 projects out of fluid line 2 and second end 20b of base body 20 is rotatably situated in fluid line 2 (cf. FIGS. 5 and 6).

Control element 3 is designed in the form of a pivoting lever and is positioned at first end 20a of cylindrical base body 20. The purpose of control element 3 in the form of a pivoting lever is to rotate or orient blocking device 10 in fluid line 2. Blocking device 10 is positioned in a fluid line 2 so that, depending on the position of blocking device 10 in fluid line 2, the flow of the fluid, i.e. of a liquid or a gas, may be blocked or unblocked. Consequently, the quantity of fluid that flows through blocking device 10 and to the machine tool may be regulated. The fluid is not shown in the figures.

Cylindrical base body 20 of blocking device 10 includes a first flow-through opening 30 and a second flow-through opening 50 (cf. FIGS. 5 and 6).

Both first flow-through opening 30 and second flow-through opening 50 include a passage through cylindrical base body 20 of blocking device 10, through which the fluid may flow. The cross section of first flow-through opening 30 is thereby smaller than the cross section of second flow-through opening 50, as a result of which a small volume of fluid per unit of time may flow through first (smaller) flow-through opening 30.

First flow-through opening 30 has an essentially wedge-shaped cross section, as a result of which the first flow-through opening 30 along the bottom of cylindrical base body 20 has a first surface 32 and a second surface 36. First surface 32 in turn has a first surface edge 33 and a second surface edge 34. Moreover, second surface 36 has a first surface edge 37, a second surface edge 38 and a third surface edge 39. Second surface 36 therefore has an essentially triangular shape (cf. FIGS. 5, 6 and 18).

First surface edge 33 of first surface 32 is adjacent to first surface edge 37 of second surface 36. Second surface edge 38 of second surface 36 runs along the lateral surface of cylindrical base body 20. Third surface edge 39 of second surface 36 runs along second flow-through opening 50.

Second flow-through opening 50 has an essentially rectangular cross section including a first wall surface 52, a second wall surface 54 and a third wall surface 56. First wall surface 52 and second wall surface 54 are opposite one another. Third wall surface 56 is essentially arc-shaped and connects first wall surface 52 to second wall surface 54.

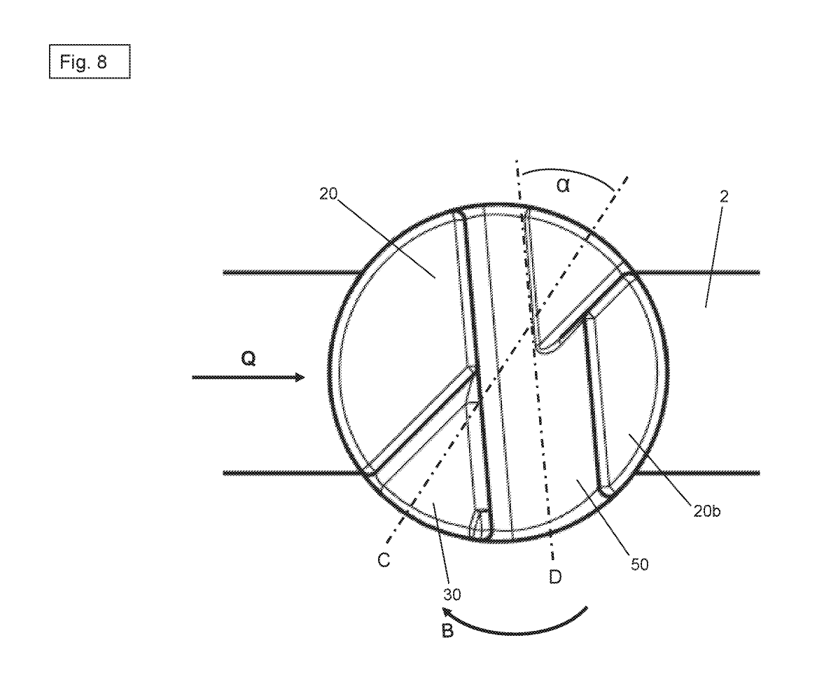

First flow-through opening 30 intersects second flow-through opening 50. As shown in FIG. 8, center line C of first flow-through opening 30 intersects center line D of second flow-through opening 50 at an obtuse angle (α).

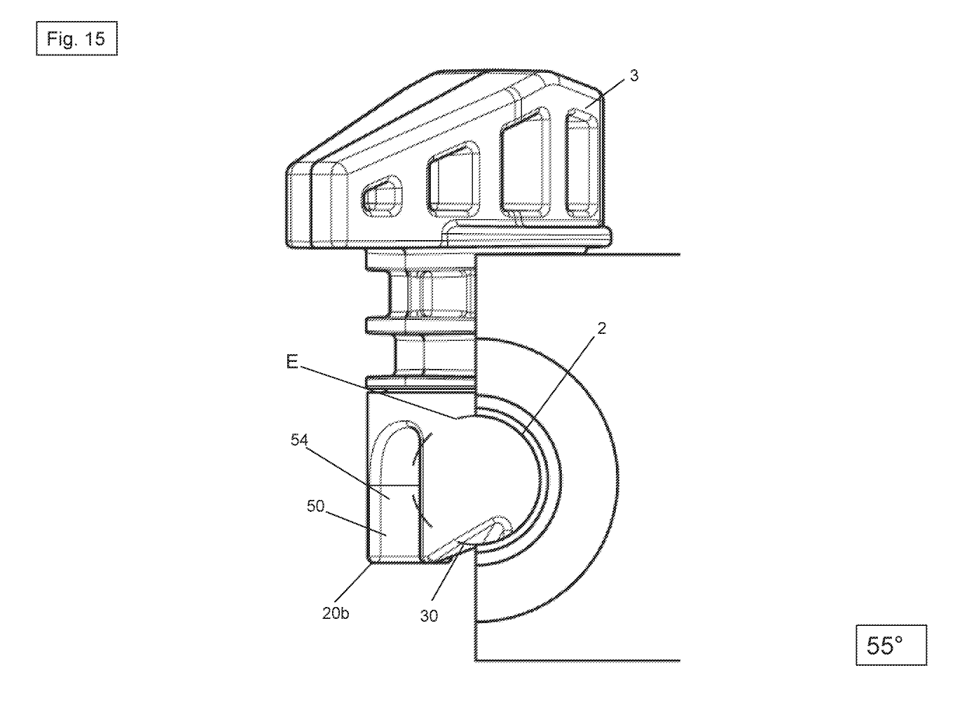

As described above, shutoff device 1 is rotatably positioned in fluid line 2. Blocking device 10 is rotatably mounted in fluid line 2. Blocking device 10 is correspondingly oriented in fluid line 2 by rotating shutoff device 1 with the aid of pivoting lever 3 in direction A or B. Depending on the respective rotational position of blocking device 10, either a larger or smaller cross section of first flow-through opening 30 is unblocked for the fluid to flow through blocking device 10. Blocking device 10 may also be completely blocked so that no fluid is able to flow through blocking device 10. As illustrated in FIG. 15, in a corresponding rotational position (55° position) of blocking device 10 it is also possible for the fluid to flow both through first flow-through opening 30 and through second flow-through opening 50.

According to one alternative embodiment of shutoff device 1 according to the present invention, it may be provided that first flow-through opening 30 is connected by a passage opening (not shown) to second flow-through opening 50. Consequently, a more rapid increase of the flow volume per unit of time through the blocking device may be achieved, since the cross section of first flow-through opening 30 is more rapidly increased by a corresponding orientation of blocking device 10 in fluid line 2 than without the additional passage opening.

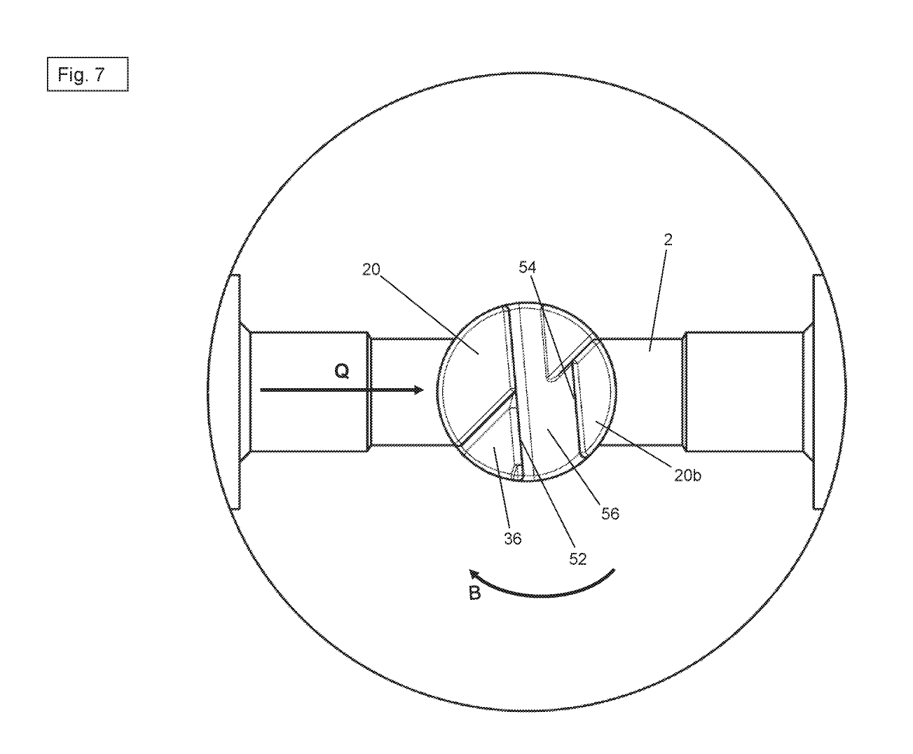

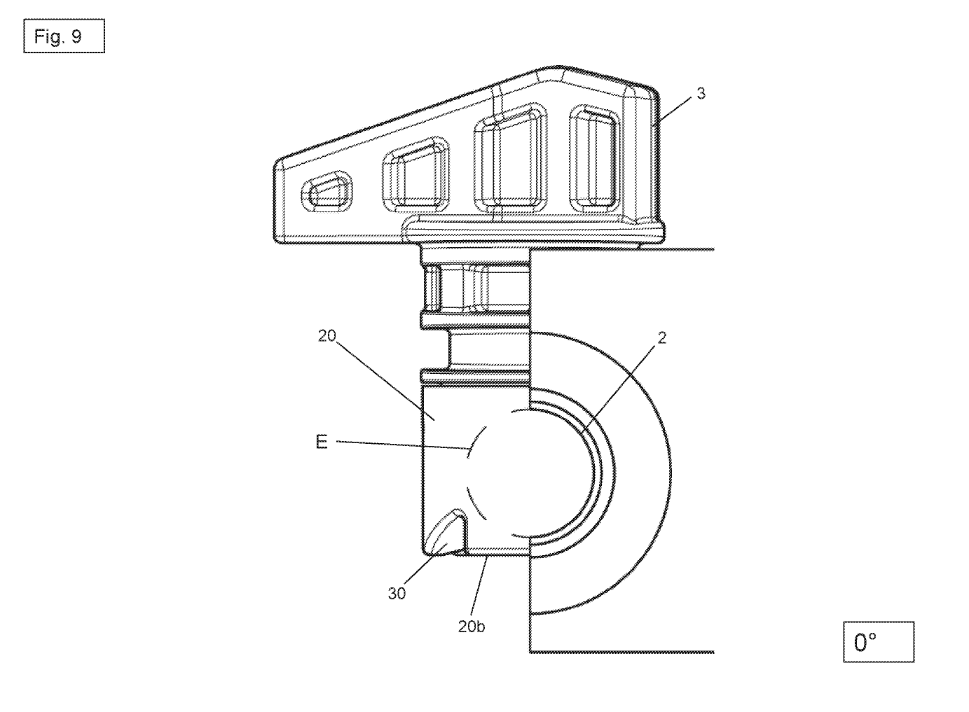

FIGS. 9 through 18 illustrate different rotational positions of blocking device 10 in fluid line 2. By rotating blocking device 10 in direction of rotation A and depending on the respective rotational position of blocking device 10, more or less fluid per unit of time may flow through blocking device 10, since the wedge-shaped cross section of first flow-through opening 30 is larger or smaller. Circle E indicates the contact surface of fluid line 2 on blocking device 10 (cf. FIGS. 5, 6, 9 through 18). The following positions in degrees refer to the respective rotation of blocking device 10 in fluid line 2 in degrees (°) with reference to the starting position (0°), in which blocking device 10 is completely closed, i.e. no fluid is able to flow through blocking device 10. To open blocking device 10 in fluid line 2, blocking device 10 is rotated in direction B (cf. FIGS. 5, 7, 8).

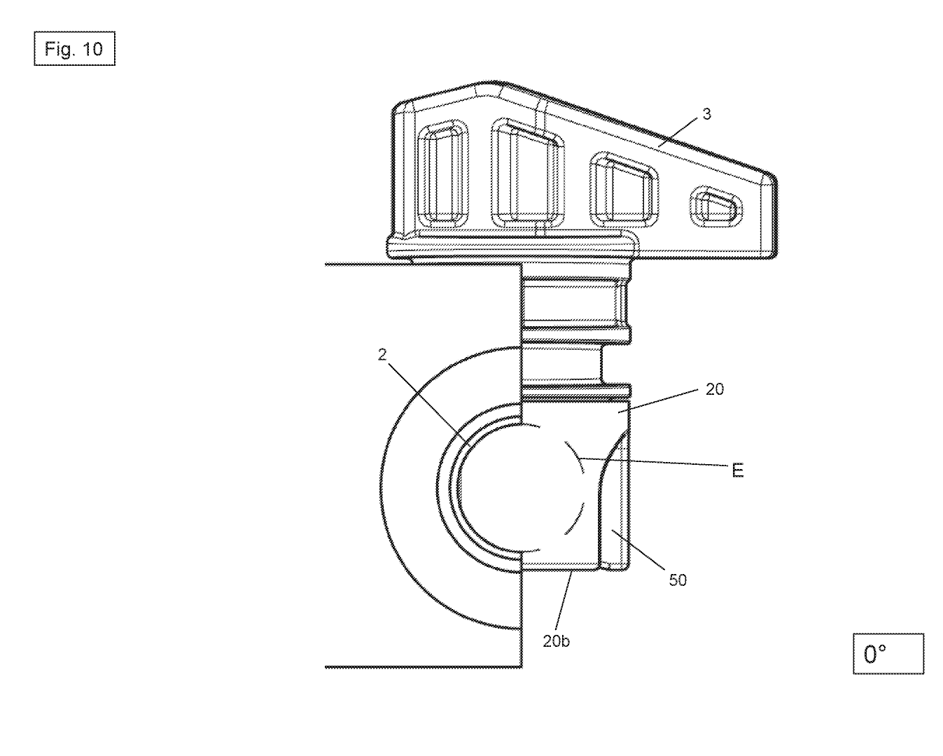

As illustrated in FIGS. 9 and 10, blocking device 10 is in a 0° position, so that first and second flow-through openings 30, 50 are closed and no fluid is able to flow through blocking device 10. FIG. 9 shows a view in flow direction Q of the fluid through fluid line 2. FIG. 10 shows a view opposite to flow direction Q of the fluid through fluid line 2.

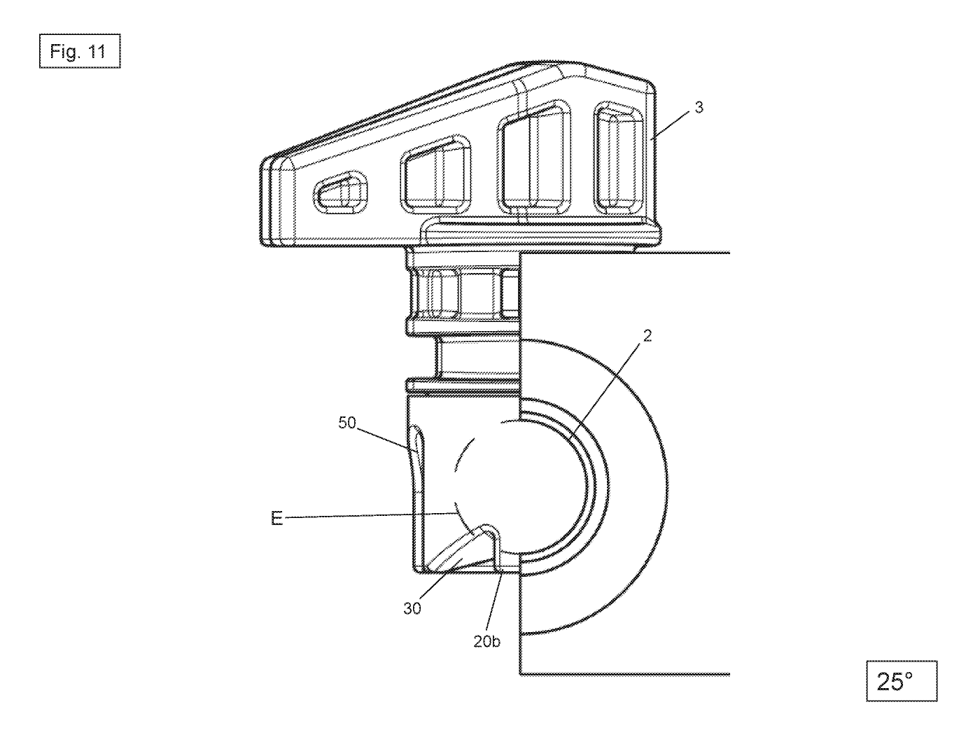

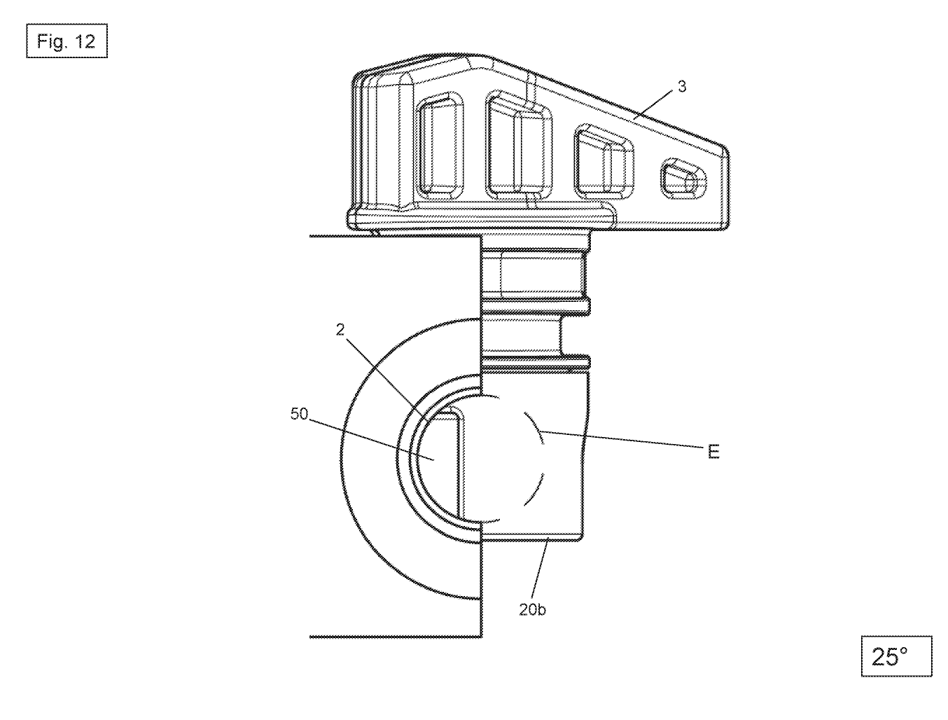

As shown in FIGS. 11 and 12, blocking device 10 is in a 25° position, so that first flow-through opening 30 is opened and a small amount of fluid is able to flow through blocking device 10. FIG. 11 shows a view in flow direction Q of the fluid through fluid line 2. FIG. 12 shows a view opposite to flow direction Q of the fluid through fluid line 2.

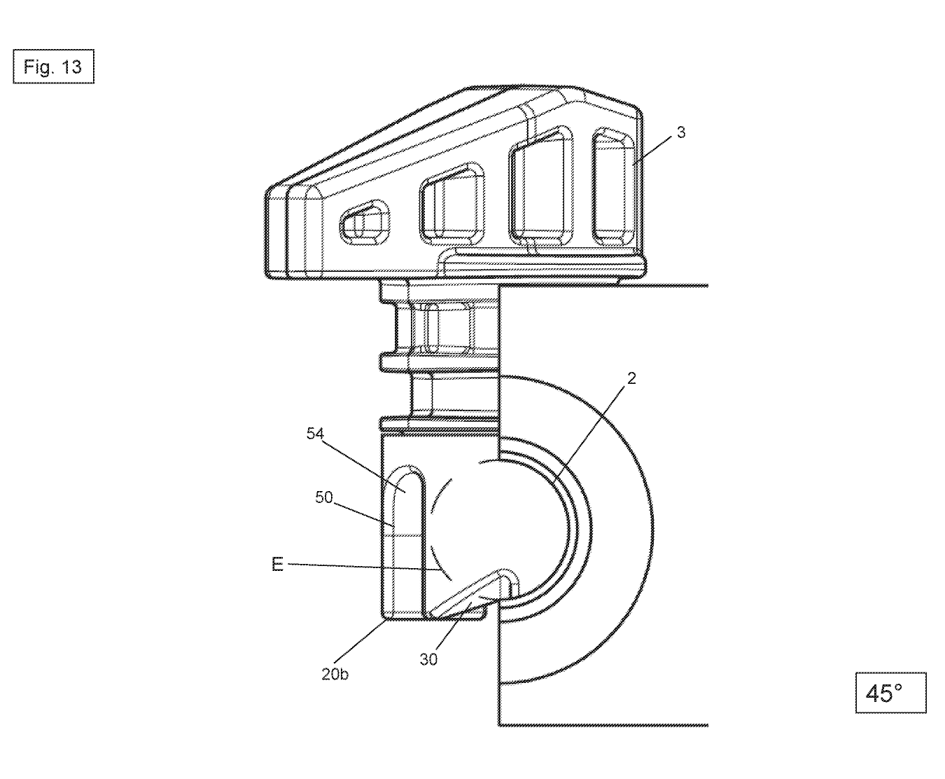

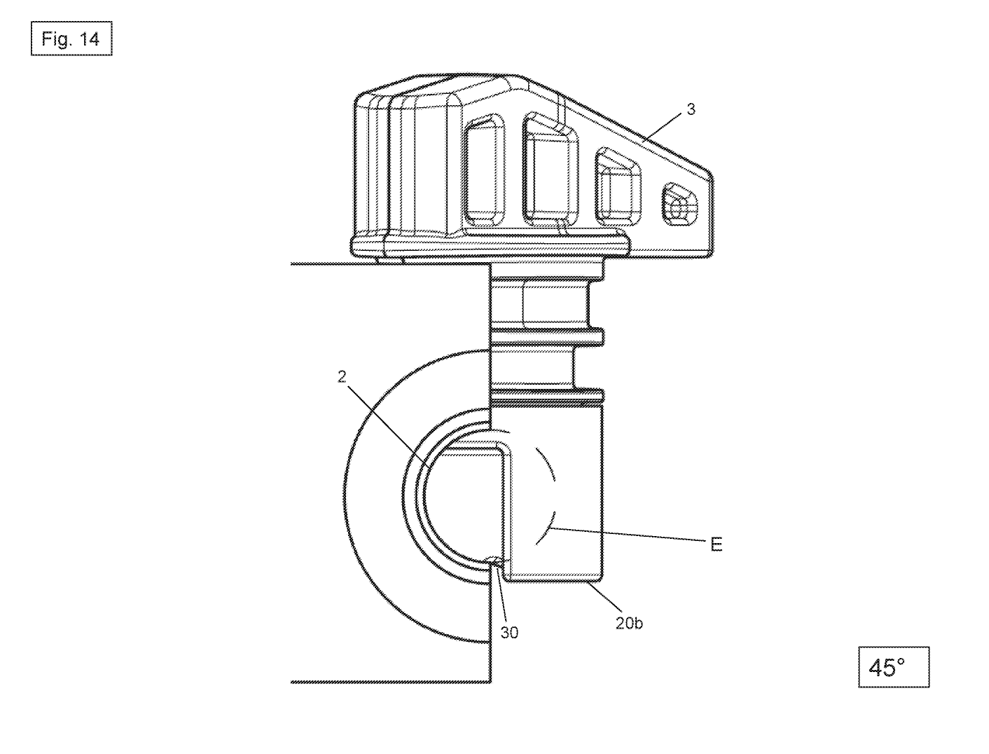

As illustrated in FIGS. 13 and 14, blocking device 10 is in a 45° position in which first flow-through opening 30 is opened somewhat farther and slightly more fluid per unit of time is able to flow through blocking device 10. FIG. 13 shows a view in flow direction Q of the fluid through fluid line 2. FIG. 14 shows a view opposite to flow direction Q of the fluid through fluid line 2.

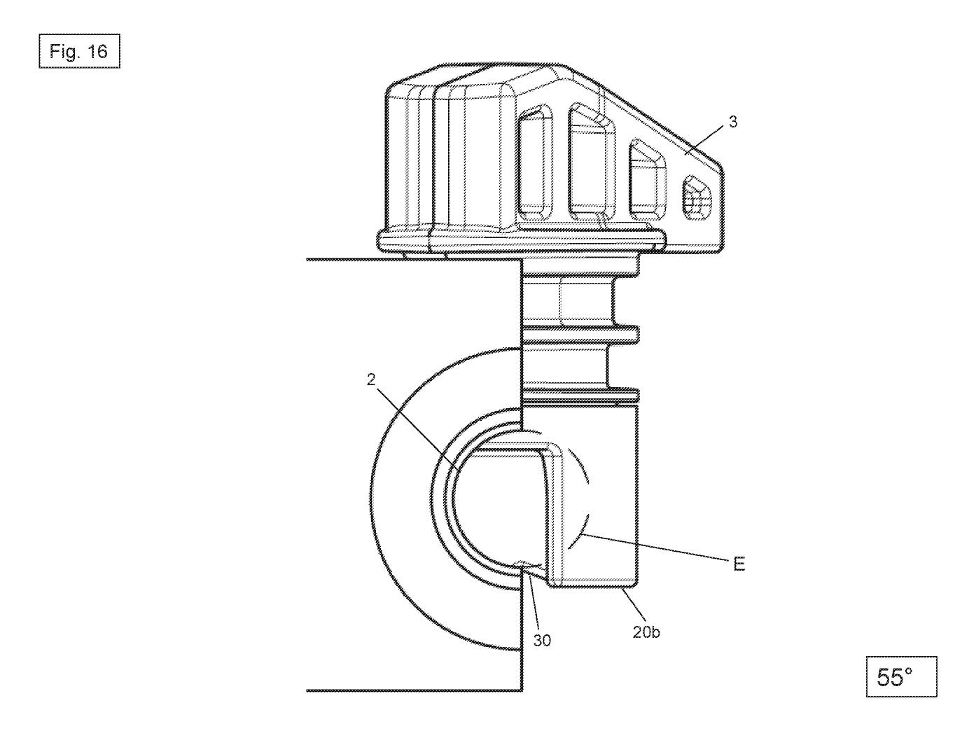

As illustrated in FIGS. 15 and 16, blocking device 10 is in a 55° position in which first flow-through opening 30 is opened to the maximum position. FIG. 15 shows a view in flow direction Q of the fluid through fluid line 2. FIG. 16 shows a view opposite to flow direction Q of the fluid through fluid line 2.

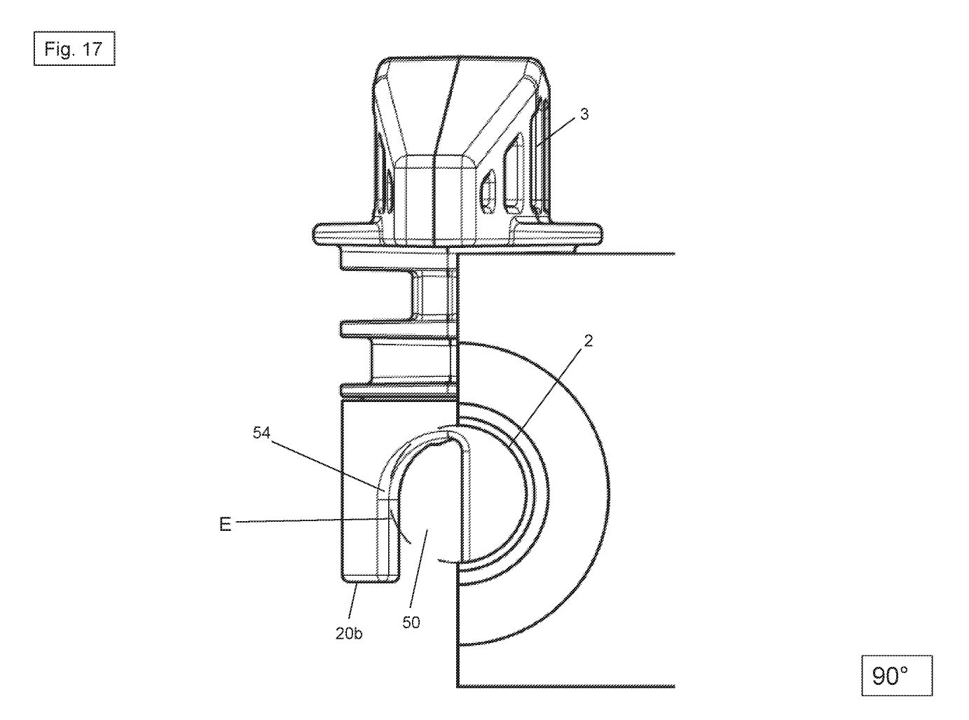

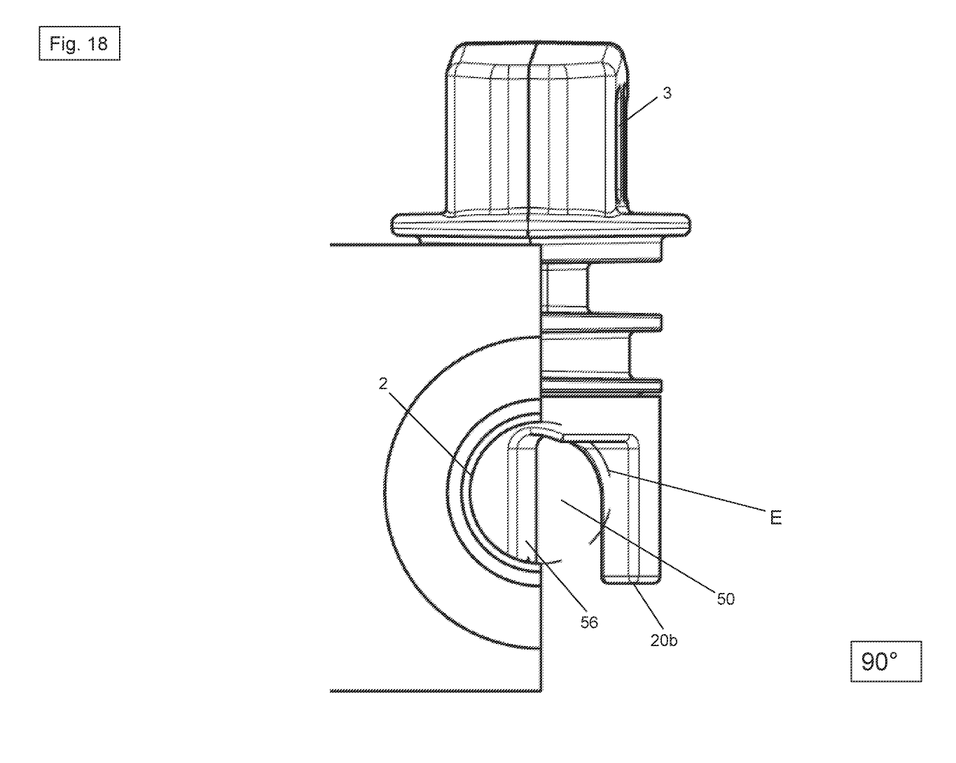

As illustrated in FIGS. 17 and 18, blocking device 10 is in a 90° position, in which second flow-through opening 50 is opened to the maximum position and first flow-through opening 30 is in turn closed. In this 90° position, the maximum volume of fluid per unit of time flows through blocking device 10. FIG. 17 shows a view in flow direction Q of the fluid through fluid line 2. FIG. 18 shows a view opposite to flow direction Q of the fluid through fluid line 2.

On account of the special wedge-shaped cross-section and the particular orientation of first flow-through opening 30 in blocking device 10, the amount of fluid that flows through blocking device 10 and is transported to the machine tool for cooling or flushing may be metered very precisely. In particular, small quantities of cooling fluid that are transported to the tool for cooling may be optimally set.

1-7. (canceled)

8. A shutoff device for at least partial blocking of a fluid in a fluid line, the shutoff device comprising:
a blocking device having a cylindrical base body having a first end and a second end, the blocking device being positionable in the fluid line and adjustable by rotation in a direction of rotation around an axis of rotation, reversibly from a blocking position where no fluid is able to flow through the blocking device into a flow-through position where fluid is able flow through the blocking device;
the blocking device having a first flow-through opening and a second flow-through opening, the cross-section of the first flow-through opening being smaller than the cross-section of the second flow-through opening.

9. The shutoff device as recited in claim 8 wherein the first flow-through opening and the second flow-through opening are connected to each other via a flow-through opening along a lateral surface of the cylindrical base body.

10. The shutoff device as recited in claim 8 wherein the first flow-through opening has a wedge-shaped cross-section.

11. The shutoff device as recited in claim 10 wherein the wedge-shaped cross-section has at least a first surface including a first surface edge and a second surface edge as well as a second surface including a further first surface edge, a further second surface edge and a third surface edge, the first surface extending in parallel to the axis of rotation and the second surface extending at an angle to the axis of rotation in such a way that a first end of the further second surface edge and a first end of the third surface edge intersect at a point at the second end of the cylindrical base body.

12. The shutoff device as recited in claim 8 wherein on the cylindrical base body of the blocking device, the first flow-through opening is positioned before the second flow-through opening opposite the direction of rotation.

13. The shutoff device as recited in claim 11 wherein on the cylindrical base body of the blocking device, the first surface of the first flow-through opening is positioned before the second surface of the first flow-through opening opposite the direction of rotation.

14. The shutoff device as recited in claim 8 wherein the blocking device is orientatable by rotation in the fluid line in such a way that a flow of fluid through the blocking device is possible only through the first flow-through opening, through the first flow-through opening and the second flow-through opening or only through the second flow-through opening.
